(19) United States
(12) Patent Application Publication
(10) Pub. No.: US 2001/0016810 A1
(43) Pub. Date: Aug. 23, 2001

(54) SIGNAL REPRODUCTION APPARATUS AND METHOD THEREFOR

(76) Inventors: YOSHIAKI OIKAWA, KANAGAWA (JP); KENZO AKAGIRI, KANAGAWA (JP); MITSUYUKI HATANAKA, KANAGAWA (JP)

Correspondence Address: CHARLES P SAMMUT, LIMBACH & LIMBACH, 2001 FERRY BUILDING, SAN FRANCISCO, CA, 941114262

(21) Appl. No.: 08/938,251

(22) Filed: Sep. 26, 1997

(30) Foreign Application Priority Data
Sep. 27, 1996 (JP) P08-256835

(51) Int. Cl. G10L 19/00

(52) U.S. Cl. 704/200.1

(57) ABSTRACT

A code-string dividing circuit outputs various types of information extracted from an input code string to a signal-component decoding circuit, and also outputs conversion-length information to a switching circuit. The signal-component decoding circuit reproduces a spectrum signal from the received information. According to the conversion-length information, the switching circuit outputs the spectrum signal to a reverse spectrum conversion circuit when the conversion length is the same as the specified value M′, and outputs the spectrum signal to a conversion-length conversion circuit when the conversion length is another value M. The conversion-length conversion circuit adds a frequency component having a value of zero to the spectrum signal corresponding to a conversion length of M to generate the spectrum signal corresponding to the conversion length M′, and outputs it to the reverse conversion circuit. The reverse conversion circuit applies reverse spectrum conversion to the received signal at a conversion length of M′, and outputs the generated acoustic wave signal.

### BACKGROUND OF THE INVENTION

1. Field of the Invention

The present invention relates to signal reproduction apparatuses and methods therefor, and more particularly, to a signal reproduction apparatus having a simple configuration for reproducing a code string generated by encoding an input signal such as digital data, and a method therefor.

2. Description of the Related Art

Various methods and apparatuses for encoding an audio signal highly efficiently have been proposed. There is known, for example, the transform coding method in which a signal in the time domain is framed in units of certain time periods, the framed signal in the time domain is converted (spectrum converted) into a signal in the frequency domain, the frequency zone of the spectrum signal obtained by the conversion is divided into a plurality of frequency bands, and the spectrum signal is coded in each band. There is also known the sub-band coding (SBC) method in which a signal in the time domain is converted to that in the frequency domain, and the signal is divided into signals in the specified number of frequency bands and coded.

It is also considered that the transform coding method and the sub-band coding method are combined. A signal in the time domain is divided into those for the specified number of frequency bands according to the sub-band coding method, and a signal in the time domain for each frequency band is converted to that in the frequency domain to generate a spectrum signal according to the transform coding method.

Sub-band filters used in the sub-band coding method includes a quadrature mirror filter described in “Digital Coding of Speech in Subbands” (written by R. E. Crochiere, Bell System Technical Journal, Vol. 55, No. 8, 1976) and a polyphase quadrature filter described in “Polyphase Quadrature Filters—A New Subband Coding Technique” (written by Joseph H. Rothweiler, ICASSP 83, Boston).

The quadrature mirror filter divides a specified frequency band into two halves so that so-called aliasing is not generated when the frequency divisions are combined. The polyphase quadrature filter can divide a specified frequency zone into a plurality of bands having the same band width at a time.

Spectrum conversion is performed, for example, by framing an input audio signal in units of specified time periods and converting the signal in each frame by a conversion method, such as discrete Fourier transform (DFT), discrete cosine transform (DCT), or modified discrete cosine transform (MDCT). The signal in the time domain is thus converted into that in the frequency domain. MDCT is described in detail in “Subband/Transform Coding Using Filter Bank Designs Based on Time Domain Aliasing Cancellation” (written by J. P. Princen and A. B. Bradley, University of Surrey Royal Melbourne, Institute of Technology, ICASSP 1987).

Since a signal divided into a plurality of frequency bands is quantized in each band in the spectrum conversion to control a band where quantization noise is generated, more highly efficient coding can be done in terms of an auditory sense with the use of a so-called masking effect. When a signal is normalized in each band before quantization by the maximum absolute value of the signal in the band, further efficient coding is performed.

In many cases, the division widths of the frequency are specified with human auditory characteristics being taken into consideration. In other words, when an audio signal is divided into a plurality of bands (for example, 25 bands), the widths of the bands are specified according to critical band widths which are broader at higher frequencies.

Specified bits are assigned to each band or bits are adaptively allocated to each band in data coding. When coefficient data generated in MDCT is coded, MCDT coefficient data in each band obtained by MDCT for each frame is coded with the number of bits adaptively allocated.

The above bit allocation method includes the following two methods.

In the method described in “Adaptive Transform Coding of Speech Signals” (written by R. Zelinski and P. Noll, IEEE Transactions of Acoustics, Speech, and Signal Processing, Vol. ASSP-25, No. 4, August 1977), bits are allocated based on the amplitude of a signal in each band. In this method, quantization-noise spectrum becomes flat and noise energy is minimum. Since the masking effect is not used, however, actual feeling of noise is not best.

In the method described in “The critical band coder—digital encoding of the perceptual requirements of the auditory system” (written by M. A. Kransner, MIT, ICASSP 1980), fixed bit allocation is performed with the use of the masking effect to provide a sufficient signal-to-noise ratio in each band. When a sine wave is input, however, since bit allocation is fixed in this method, most suited bit allocation is not performed (described later).

To solve these problems, a method has been proposed in which all bits which can be allocated are divided into those for fixed bit allocation specified in advance for each band or each block which is a division of each band, and those for bit allocation according to the amplitude of a signal in each block. The ratio of the divisions of the bits is specified according to an input signal. When the spectrum distribution of an input signal is smoother, for example, the ratio of the fixed allocation bits may be set higher.

When input energy is concentrated at a certain spectrum component as in a sine-wave input, for example, since many bits are allocated to a block including the spectrum component in this method, the overall signal-to-noise characteristic is substantially improved. Since generally a human auditory sense is extremely sensitive to a signal having a steep spectrum distribution, it is effective for improving sound quality in an auditory sense to improve signal-to-noise characteristics by the use of this method.

Many bit allocation methods other than those described above have been proposed. When a finer model of an auditory sense is achieved and the capability of a coding unit improves, more highly efficient coding in terms of an auditory sense becomes possible.

When a waveform signal formed of waveform elements (sampled data) such as a digital audio signal in the time domain is spectrum-converted with the use of DFT or DCT, a block is formed of N sampled data items, for example, and spectrum conversion such as DFT or DCT is applied to each block. When such a block is spectrum-converted, N independent real-number data items (DFT coefficient data or DCT coefficient data) are obtained. The obtained N real-number data items are quantized and coded to be converted into coded data.

When this coded data is decoded to reproduce a reproduction waveform signal, the coded data is decoded and dequantized, the obtained real-number data is reverse-spectrum-converted with the use of reverse DFT or reverse DCT for each block corresponding to the block in coding to generate a waveform-element signal, and all blocks each having this waveform-element signal are connected.

The reproduction waveform signal generated in this way has connection distortion caused when the blocks are connected, which is not preferable in an auditory sense. To reduce connection distortion between blocks, spectrum conversion is performed with the use of DFT or DCT with N₁ sampled data items being overlapped at the boundary of adjacent two blocks in actual coding.

When spectrum conversion is performed in this way, N real-number data items are obtained from (N−N₁) sampled data items on average. The number of the original sampled data items actually used for spectrum conversion is smaller than the number of the real-number data items obtained by the spectrum conversion. Since the real-number data is quantized and coded, it is not preferable in terms of coding efficiency that the number of the real-number data items obtained by the spectrum conversion increase relative to the number of the original sampled data items.

When a waveform signal formed of sampled data such as a digital audio signal is spectrum-converted with the use of MDCT, N sample data items are overlapped at the boundary of adjacent blocks in order to reduce connection distortion between blocks, and 2N sampled data items are spectrum-converted to obtain N independent real-number data (MDCT coefficient data). Therefore, N real-number data items are obtained from N sampled data items on average in the spectrum conversion with the use of MDCT, and more efficient coding is performed than that in the spectrum conversion with the use of DFT or DCT.

To reproduce a reproduction waveform signal by decoding the code string generated by quantizing and coding a real-number data obtained by the MDCT spectrum conversion, the code string is decoded and dequantized, the obtained real-number data is reverse-spectrum-converted with the use of reverse MDCT to generate waveform elements in blocks, and the waveform elements in blocks are added with interference with each other to reconfigure the waveform signal.

$$\begin{matrix}{x}_{1 , J} ( n ) = {w}_{1} ( n ) \times ( n + JM ) \\ 0 \leq n < 2 M & ( 1 ) \\ {X}_{j} ( k ) = \frac{2}{M} {\sum }_{n = 0}^{2 M - 1} {X}_{1 , J} ( n ) cos \frac{π ( 2 k + 1 ) ( 2 n + M + 1 )}{4 M} \\ 0 \leq k < M & ( 2 )\end{matrix}$$

Equations (1) and (2) indicate MDCT conversion expressions. MDCT requires windowing expressed by equation (1) and MDCT conversion expressed by equation (2). M indicates a conversion length, J indicates the j-th block, and x(n+JM) indicates the (n+JM)-th input data.

$$\begin{matrix}{x}_{2 , J} ( n ) = {\sum }_{k = 0}^{M - 1} {X}_{J} ( k ) cos \frac{π ( 2 k + 1 ) ( 2 n + M + 1 )}{4 M} \\ 0 \leq n < 2 M & ( 3 ) \\ {x}_{3 , J} ( n ) = {w}_{2} ( n ) {x}_{2 , J} ( n ) \\ 0 \leq n < 2 M & ( 4 ) \\ y ( n + JM ) = {x}_{3 , J - 1} ( n + M ) + {X}_{3 , J} ( n ) \\ 0 \leq n < M & ( 5 )\end{matrix}$$

Equations (3) to (5) indicate reverse MDCT. Reverse MDCT includes reverse-MDCT conversion expressed by equation (3), windowing expressed by equation (4), and overlapping expressed by equation (5).

$$\begin{matrix}{w}_{1} ( n ) {w}_{2} ( n ) + {w}_{1} ( n + M ) {w}_{2} ( n + M ) = 1 \\ 0 \leq n < M & ( 6 ) \\ {w}_{1} ( 2 M - n - 1 ) {w}_{2} ( n + M ) = {w}_{1} ( M - n - 1 ) {w}_{2} ( n ) \\ 0 \leq n < M & ( 7 )\end{matrix}$$

Equations (6) and (7) show conditions required to a windowing function used in MDCT and reverse MDCT in order to reconfigure a waveform signal.

TABLE 1

| | | |
|---|---|---|
| Conversion length | 1024 | 256 |
| No. of sum-of-products operations | 19968 | 4224 |
| Required RAM capacity | 1536 | 811 |
| (1 word = 32 bits) | | |

Table 1 shows the number of sum-of-products operations and a required RAM capacity in reverse MDCT at a conversion length of 1024 or 256. The required RAM capacity is specified such that an error in an 16-bit output PCM data is within LSB/2 when the sum of products is calculated in floating-point operations. When the conversion length is changed from 1024 to 256, the number of sum-of-products operations decreases to 21% and the required RAM capacity decreases to 52% in the reverse spectrum conversion circuit according to Table 1.

FIG. 3 shows a first example of a conventional signal transmission apparatus 1 for acoustic wave signals.

In the signal transmission apparatus shown in FIG. 3, an acoustic wave signal in the time domain input to an input terminal 11 is converted to a spectrum signal (signal frequency component) in the frequency domain in a spectrum conversion circuit 12, and normalized and quantized in a normalization/quantization circuit 14 with the use of quantization-precision information obtained by a quantization-precision determination circuit 13.

The normalization/quantization circuit 14 outputs normalization-coefficient information and a coded spectrum signal to a code-string generation circuit 15. The code-string generation circuit 15 generates a code string from the quantization-precision information, the normalization-coefficient information, and the coded spectrum signal. The code string is output through an output terminal 16 and recorded in a recording medium (not shown) or transmitted through a transmission line.

FIG. 4 shows a specific configuration example in a case when MDCT is used for conversion in the spectrum conversion circuit 12 shown in FIG. 3.

In the spectrum conversion circuit 12 (in FIG. 4), an acoustic wave signal input to the input terminal 11 shown in FIG. 3 is sent to a windowing circuit 22 through a terminal 21. The windowing circuit 22 performs windowing expressed by equation (1) with the use of a window coefficient sent from a unit (not shown) through an input terminal 23. A windowed signal output from the windowing circuit 22 is sent to an MDCT circuit 24. The MDCT circuit 24 performs MDCT expressed by equation (2). A spectrum signal output from the MDCT circuit 24 is sent to the subsequent circuit through a terminal 25 as the spectrum signal from the spectrum conversion signal 12 shown in FIG. 13.

Coding preformed in the signal transmission circuit shown in FIG. 3 will be described below by referring to FIG. 5.

FIG. 5 shows the level of the absolute value of a spectrum signal (frequency component) obtained by MDCT in dB. FIG. 5 also shows a normalization coefficient for each coding unit.

64 spectrum signal components ES are obtained by converting an acoustic wave signal in each specified time frame in the spectrum conversion circuit 12 shown in FIG. 3. These components ES are grouped at each band (hereinafter this group is called a coding unit) in a specified zone (band b1 to band b5). The normalization/quantization circuit 14 applies normalization and quantization to these groups. In band b1, for example, there are eight spectrum signal components ES. Since the spectrum signal component having the lowest frequency has the maximum amplitude, the amplitude is selected as a normalization coefficient. Each spectrum signal component in this block is divided by this normalization coefficient and the remainder is quantized.

The quantization-precision determination circuit 13 determines quantization precision for each coding unit by calculating the minimum audible level and a masking level in the frequency band corresponding to each coding unit according to, for example, an auditory-sense model. Frequency-band widths are specified for coding units such that a width is narrower at a lower frequency band and wider at a higher frequency band, thereby generation of quantization noise can be controlled in response to the characteristic of the auditory sense.

FIG. 6 shows a code string generated by the signal transmission apparatus shown in FIG. 3 and output from the terminal 16.

The code string shown in FIG. 6 is formed of the information U1 to U5 of five coding units. Each information includes quantization-precision information, normalization-coefficient information, and normalized and quantized signal-component information SCi. The coding string is recorded in a recording medium such as a magneto-optical disk. If quantization-precision information is null as in the coding-unit information U 4, the information is not coded.

FIG. 7 shows a specific configuration example of a signal reproduction apparatus which reproduces an acoustic wave signal from the information of a code string generated by the signal transmission apparatus shown in FIG. 3 and outputs it.

In the signal reproduction apparatus shown in FIG. 7, a code string which corresponds to that output from the terminal 16 shown in FIG. 3 is input to a code-string dividing circuit 42 through an input terminal 41. The code-string dividing circuit 42 extracts normalization-coefficient information, signal frequency components, and quantization-precision information from the input code string and outputs them to a signal-component decoding circuit 43.

The signal-component decoding circuit 43 reproduces a spectrum signal which the spectrum conversion circuit 12 shown in FIG. 3 outputs, from the normalization-coefficient information, signal frequency components, and quantization-precision information, and outputs it to a reverse spectrum conversion circuit 44. The reverse spectrum conversion circuit 44 performs reverse spectrum conversion at the same conversion length as that used in the spectrum conversion circuit 12 to generate an acoustic wave signal, and outputs it from an output terminal 45.

FIG. 8 shows a specific configuration example of the reverse spectrum conversion circuit 44 shown in FIG. 7 in which reverse MDCT is used.

In the reverse spectrum conversion circuit 44 shown in FIG. 8, the spectrum signal sent from the signal-component decoding circuit 43 through a terminal 51 is input to a reverse MDCT circuit 52. The reverse MDCT circuit 52 applies reverse MDCT expressed by equation (3) to the spectrum signal, and outputs the processed signal to a windowing circuit 53. The windowing circuit 53 performs windowing expressed by equation (4) with the use of a window coefficient sent from a unit (not shown) through an input terminal 54. With this process, data smoothly continues when the subsequent overlapping circuit 55 performs overlapping. The windowing circuit 53 outputs a signal to the overlapping circuit 55. The overlapping circuit 55 performs overlapping expressed by equation (5). An acoustic wave signal output from the overlapping circuit 55 is sent to the output terminal 45 through an terminal 56 as an acoustic wave signal from the reverse spectrum conversion circuit 44 shown in FIG. 7.

FIG. 9 shows a second configuration example of a conventional signal transmission apparatus for an acoustic wave signal.

In the signal transmission apparatus shown in FIG. 9, an acoustic wave signal input to an input terminal 11 is divided, for example, into those in four frequency bands by a band division filter 17 in which the above described polyphase quadrature filter, for example, is used. The four signals in the time domain are converted into spectrum signals (signal frequency components) in the frequency domain by spectrum conversion circuit 12-1 to 12-4, and normalized and quantized by a normalization/quantization circuit 14 with the use of quantization-precision information obtained by a quantization-precision determination circuit 13.

Since the spectrum conversion circuits 12-1 to 12-4 handle input signals having the band width one fourth that of the original signal, the circuits apply spectrum conversion to the input signals at the conversion length one fourth that for the original signal.

FIG. 10 shows a specific configuration example of a signal reproduction apparatus for reproducing an acoustic wave signal from the information of a code string generated by the signal transmission apparatus shown in FIG. 9 and for outputting the signal.

In the signal reproduction apparatus shown in FIG. 10, a code string which corresponds to that output from the terminal 16 shown in FIG. 9 is input to a code-string dividing circuit 42 through an input terminal 41. The code-string dividing circuit 42 extracts normalization-coefficient information, signal frequency components, and quantization-precision information from the input code string and outputs them to a signal-component decoding circuit 43.

The signal-component decoding circuit 43 reproduces four spectrum signals which the spectrum conversion circuits 12-1 to 12-4 shown in FIG. 9 output, from the normalization-coefficient information, signal frequency components, and quantization-precision information, and outputs them to a reverse spectrum conversion circuits 44-1 to 44-4.

The reverse spectrum conversion circuits 44-1 to 44-4 perform reverse spectrum conversion at the same conversion length as that used in the spectrum conversion circuits 12-1 to 12-4 to generate acoustic wave signals, and output them to a band combination filter 46. The band combination filter 46 combines the four-band signals sent from the reverse spectrum conversion circuits 44-1 to 44-4, and outputs the combined signal from an output terminal 45.

As described above, spectrum conversion and reverse spectrum conversion may be performed at a conversion length one fourth that for the original signal. A code reproduced by the signal reproduction apparatus shown in FIG. 10 includes an aliasing signal component caused by the processing in the band division filter 17. This aliasing signal component is canceled by the band combination filter 46. Since the aliasing signal component is included in a code, the amount of information actually transmitted decreases.

As shown in FIG. 11, a reverse spectrum conversion circuit 72 which performs reverse spectrum conversion at the same conversion length as that for the reverse spectrum conversion circuits 44-1 to 44-4 handles only the spectrum signal having the lowest frequency band among the four spectrum signals.

A signal to which the reverse spectrum conversion circuit 72 applies reverse spectrum conversion is oversampled as a factor of four by an oversampling circuit 73. With this oversampling, the sampling rate in this apparatus matches that in the signal transmission apparatus.

The circuit scale of the apparatus can be reduced by applying reverse spectrum conversion just to the spectrum signal having the lowest frequency band as described above.

When only one fourth of all signal components is used to generate a reproduction signal as shown in FIG. 11, the reproduction signal deteriorates. If such deterioration in the auditory sense is tolerable, practically it is not a problem.

As described above, a code string having a specified conversion length and a code string having another conversion length (such as one fourth) can be reproduced by the use of the signal reproduction apparatus shown in FIG. 7 or that shown in FIG. 11 according to a conversion length in spectrum conversion. When a reproduction signal needs to have high sound quality, for example, the signal transmission apparatus shown in FIG. 3 and the signal reproduction apparatus shown in FIG. 7 are used.

When a code string converted at two conversion lengths is input to the above signal reproduction apparatuses, it is troublesome to use one of the two apparatuses according to a conversion length in spectrum conversion. In addition, since two apparatuses are required, the circuit scale is large.

To reproduce a code string having a specified conversion length M′ and a code string having another conversion length M (such as one fourth M′) by one apparatus, it can be considered, for example, that a signal reproduction apparatus shown in FIG. 12 is used.

In the signal reproduction apparatus shown in FIG. 12, a code-string dividing circuit 42 A extracts normalization-coefficient information, signal frequency components, and quantization-precision information from an input code string, and outputs them to a signal-component decoding circuit 43A. In addition, the code-string dividing circuit 42A extracts the conversion-length information of the code string and outputs the information to the signal-component decoding circuit 43A and a switching circuit 81.

The signal-component decoding circuit 43A reproduces a spectrum signal from the normalization-coefficient information, the signal frequency components, the quantization-precision information, and the conversion-length information, and outputs it to the switching circuit 81.

According to the conversion-length information sent from the code-string dividing circuit 42A, the switching circuit 81 outputs the spectrum signal to a reverse spectrum conversion circuit 44 when the received code string has the specified conversion length M′ (conversion length used in the spectrum conversion circuit 12 ), and outputs the spectrum signal to a reverse spectrum conversion circuit 72 when the received code string has another conversion length M (for example, conversion length (M′/4) used in the spectrum conversion circuits 12-1 to 12-4).

The reverse spectrum conversion circuit 44 performs reverse spectrum conversion at the same conversion length M′ as that used in the spectrum conversion circuit 12 to generate an acoustic wave signal, and outputs it from an output terminal 45.

The reverse spectrum conversion circuit 72 performs reverse spectrum conversion at the same conversion length (M′/4) as that used in the spectrum conversion circuits 12-1 to 12-4 to generate an acoustic wave signal, and outputs it to an oversampling circuit 73.

The oversampling circuit 73 applies oversampling to the input signal at the factor (of four in this case) corresponding to the conversion length in the reverse spectrum conversion circuit 72, and outputs it from the output terminal 45.

As described above, in the signal reproduction apparatus shown in FIG. 11, when the same conversion length (M′/4) as that in the spectrum conversion circuits 12-1 to 12-4 is used, the sampling rate is adjusted with the use of the oversampling circuit 73.

When one reproduction apparatus is used for a plurality of conversion lengths as described above, however, since it is required to have the oversampling circuit 73, which adjusts the sampling rate, and a plurality of reverse spectrum conversion circuits 44 and 72 having different conversion lengths, it is difficult to reduce the circuit scale. In addition, an output signal includes a time delay due to filtering in the oversampling circuit 73.

### SUMMARY OF THE INVENTION

The present invention has been made to solve the above problems.

Accordingly, it is an object of the present invention to provide a signal reproduction apparatus having a reduced circuit scale by adjusting the frequency band of a spectrum signal according to the conversion length, and a method therefor.

The foregoing object is achieved in one aspect of the present invention through the provision of a signal reproduction apparatus including: decoding means for decoding a code string generated by coding a spectrum signal in the frequency domain obtained by applying spectrum conversion to an acoustic wave signal in the time domain at a first conversion length or a second conversion length; first conversion means for converting the spectrum signal having the first conversion length generated by the decoding means to a spectrum signal in the frequency band corresponding to the second conversion length; and second conversion means for applying reverse spectrum conversion at the second conversion length to the spectrum signal having the second conversion length generated by the decoding means or the spectrum signal having the second conversion length generated by the first converting means.

In the signal reproduction apparatus, the decoding means decodes a code string generated by coding a spectrum signal in the frequency domain obtained by applying spectrum conversion to an acoustic wave signal in the time domain at a first conversion length or a second conversion length; the first conversion means converts the spectrum signal having the first conversion length generated by the decoding means to a spectrum signal in the frequency band corresponding to the second conversion length; and second conversion means applies reverse spectrum conversion at the second conversion length to the spectrum signal having the second conversion length generated by the decoding means or the spectrum signal having the second conversion length generated by the first converting means.

The foregoing object is achieved in another aspect of the present invention through the provision of a signal reproduction method including the steps of: decoding a code string generated by coding a spectrum signal in the frequency domain obtained by applying spectrum conversion to an acoustic wave signal in the time domain at a first conversion length or a second conversion length; converting the spectrum signal having the first conversion length generated by the decoding to a spectrum signal in the frequency band corresponding to the second conversion length; and applying reverse spectrum conversion at the second conversion length to the spectrum signal having the second conversion length generated by the decoding or by the converting.

In the signal reproduction method, a code string generated by coding a spectrum signal in the frequency domain obtained by applying spectrum conversion to an acoustic wave signal in the time domain is decoded at a first conversion length or a second conversion length; when the spectrum signal has the first conversion length, the spectrum signal is converted to a spectrum signal in the frequency band corresponding to the second conversion length; and reverse spectrum conversion is applied at the second conversion length to the spectrum signal having the second conversion length generated by the decoding or by the converting.

According to the present invention, since a code string is decoded, the decoded signal, namely, a spectrum signal having a first conversion length, is converted to a spectrum signal in the frequency band corresponding to a second conversion length, and reverse spectrum conversion is applied to the spectrum signal having the second conversion length, at the second conversion length, an oversampling circuit becomes unnecessary and the circuit scale is reduced.

### BRIEF DESCRIPTION OF THE DRAWINGS

FIG. 1 is a block diagram of a signal reproduction apparatus according to an embodiment of the present invention.

FIG. 2 is a chart showing the processing of a conversion-length conversion circuit shown in FIG. 1.

FIG. 3 is a block diagram showing a first configuration example of a conventional signal transmission apparatus.

FIG. 4 is a block diagram of a spectrum conversion circuit shown in FIG. 3.

FIG. 5 is a view showing coding units in frames.

FIG. 6 is a view of a code string coded by the conventional signal transmission apparatus.

FIG. 7 is a block diagram showing a first configuration example of a conventional signal reproduction apparatus.

FIG. 8 is a block diagram of a reverse spectrum conversion circuit shown in FIG. 7.

FIG. 9 is a block diagram showing a second configuration example of a conventional signal transmission apparatus.

FIG. 10 is a block diagram showing a second configuration example of a conventional signal reproduction apparatus.

FIG. 11 is a block diagram of another configuration example of a conventional signal reproduction apparatus.

FIG. 12 is a block diagram of a signal reproduction apparatus.

### DETAILED DESCRIPTION OF THE PREFERRED EMBODIMENT

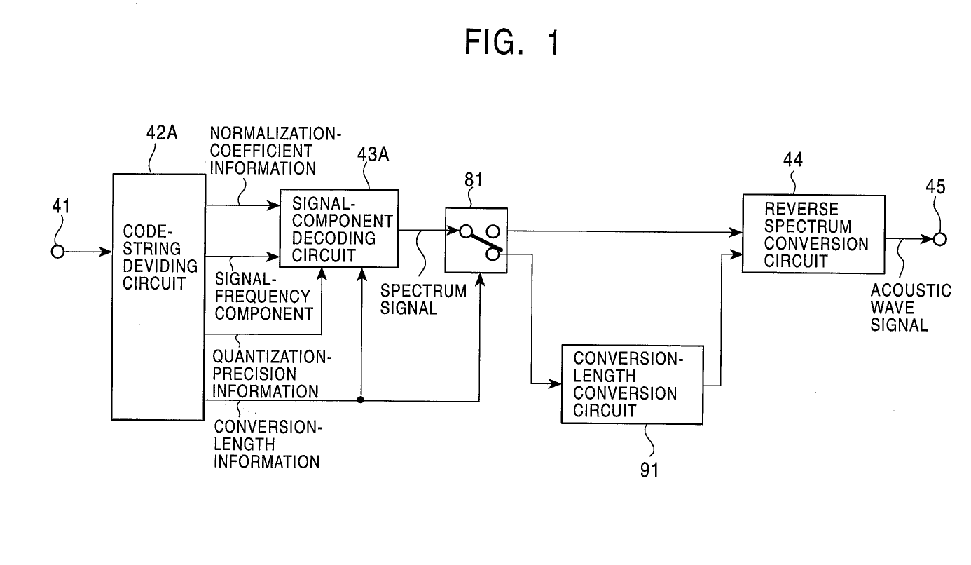

FIG. 1 shows a signal reproduction apparatus according to one embodiment of the present invention.

In the signal reproduction apparatus shown in FIG. 1, since a code-string dividing circuit 42A, a signal-component decoding circuit 43A (decoding means), and a reverse spectrum conversion circuit 44 (second conversion means) are the same as those shown in FIG. 12, the descriptions thereof will be omitted.

According to conversion-length information sent from the code-string dividing circuit 42A, a switching circuit 81 outputs a spectrum signal to the reverse spectrum conversion circuit 44 when the received code string has the specified conversion length M′ (conversion length used in the spectrum conversion circuit 12, second conversion length), and outputs the spectrum signal to a conversion-length conversion circuit 91 (first conversion means) when the received code string has another conversion length M (for example, conversion length (M′/4) used in the spectrum conversion circuits 12-1 to 12-4, first conversion length).

The conversion-length conversion circuit 91 adds a frequency component having a value of zero to the spectrum signal X_{J} (k) corresponding to the conversion length M to generate a spectrum signal X_{J}′ (k) in the frequency band corresponding to the conversion length M′ used in the spectrum conversion circuit 12, and outputs it to the reverse spectrum conversion circuit 44.

$${X}_{J} ( k ) = \{ \begin{matrix}{X}_{J} ( k ) , & 0 \leq k \leq M \\ 0 , & M \leq k \leq {M}^{′}\end{matrix} \qquad ( 8 )$$

Where M′=4×M.

An operation of the signal reproduction apparatus shown in FIG. 1 will be described next.

The code-string dividing circuit 42A divides a signal input to a terminal 41 into normalization-coefficient information, a spectrum signal, quantization-precision information, and conversion-length information. The signal-component decoding circuit 43A decodes a spectrum signal according to the normalization-coefficient information, the quantization-precision information, and the conversion-length information, and outputs it to the switching circuit 81.

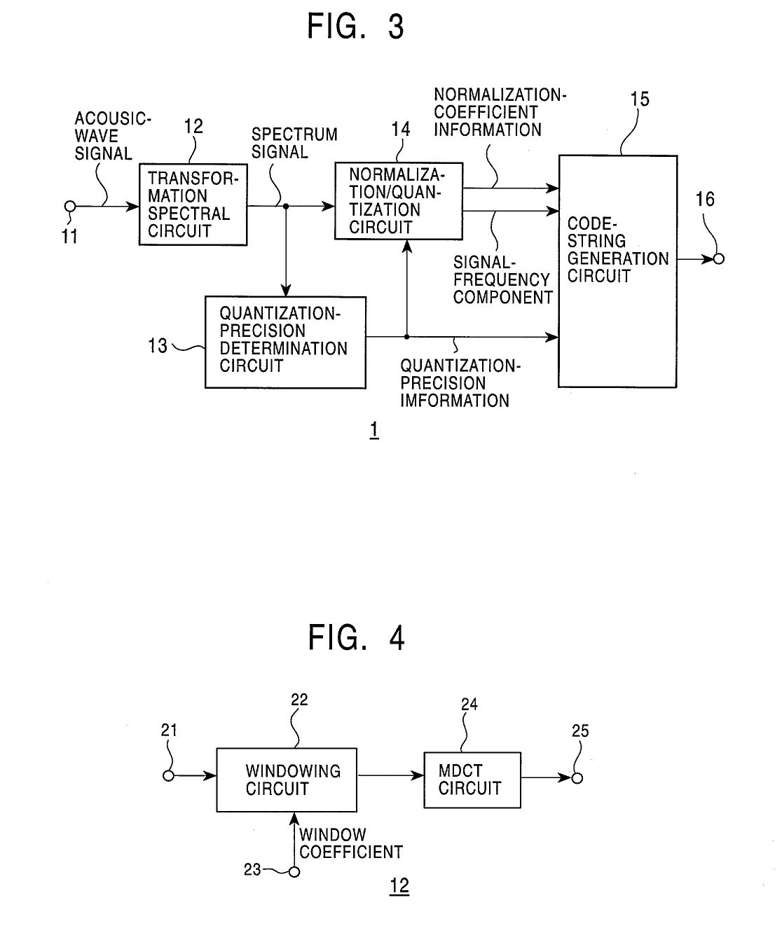

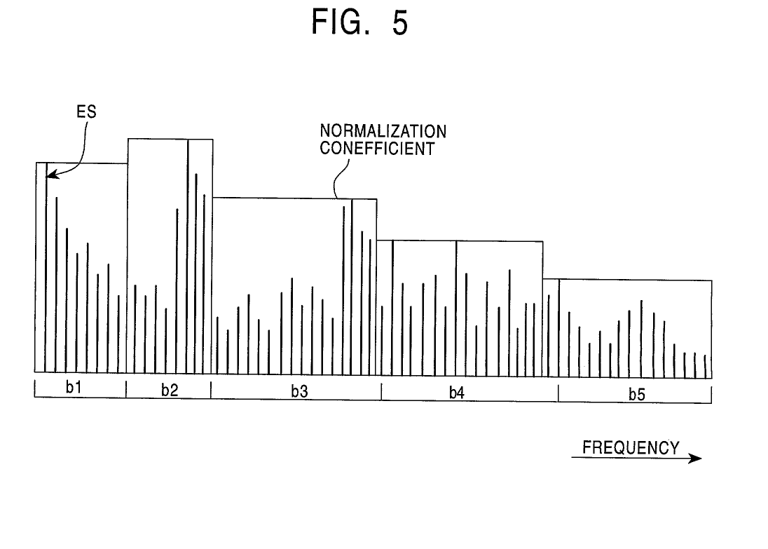

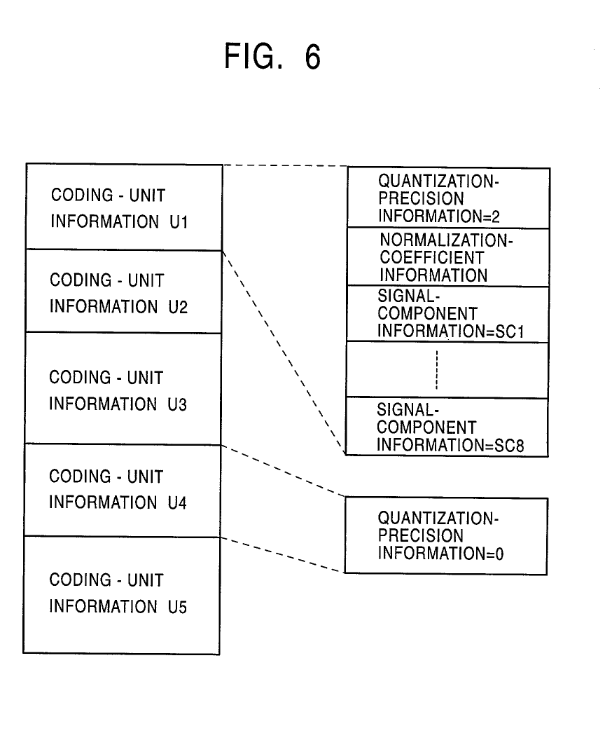

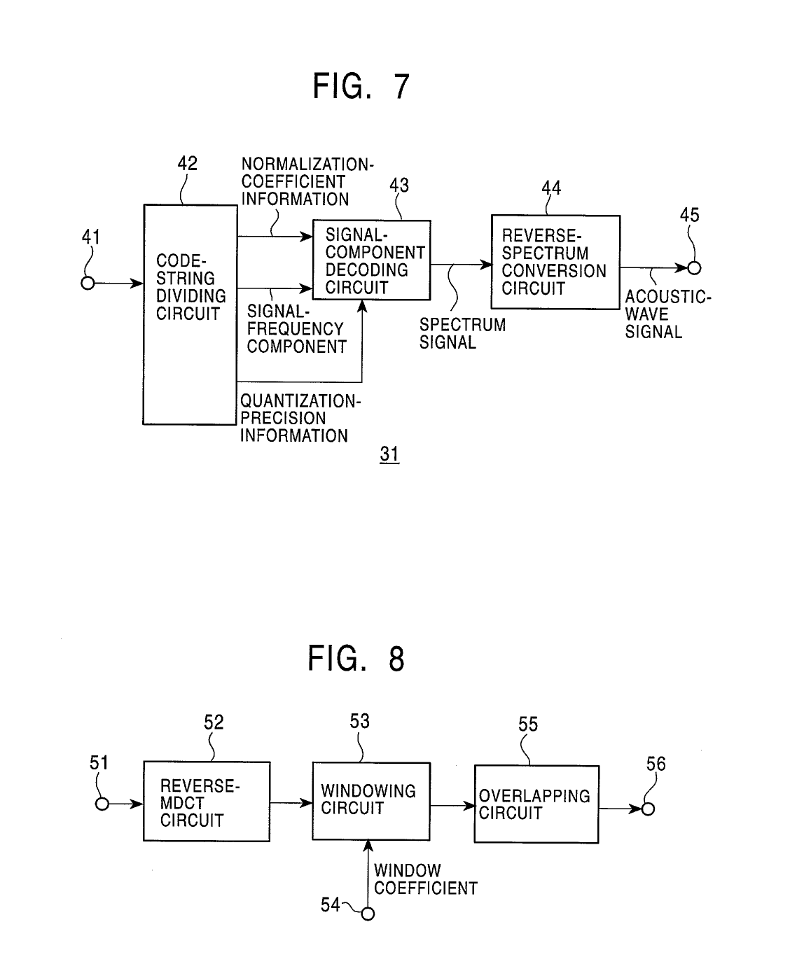

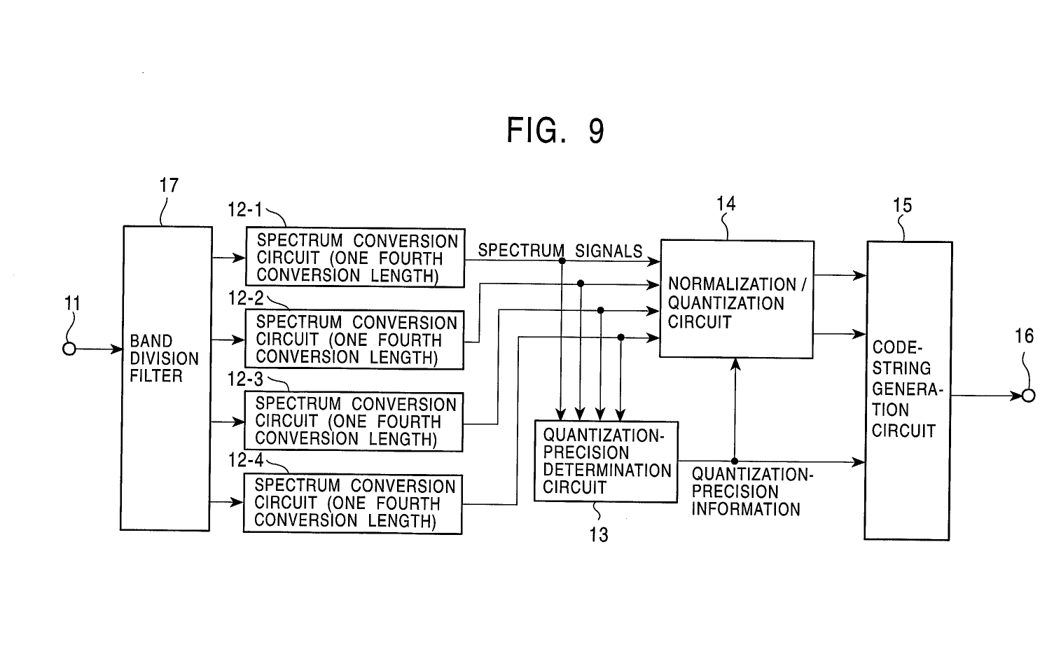

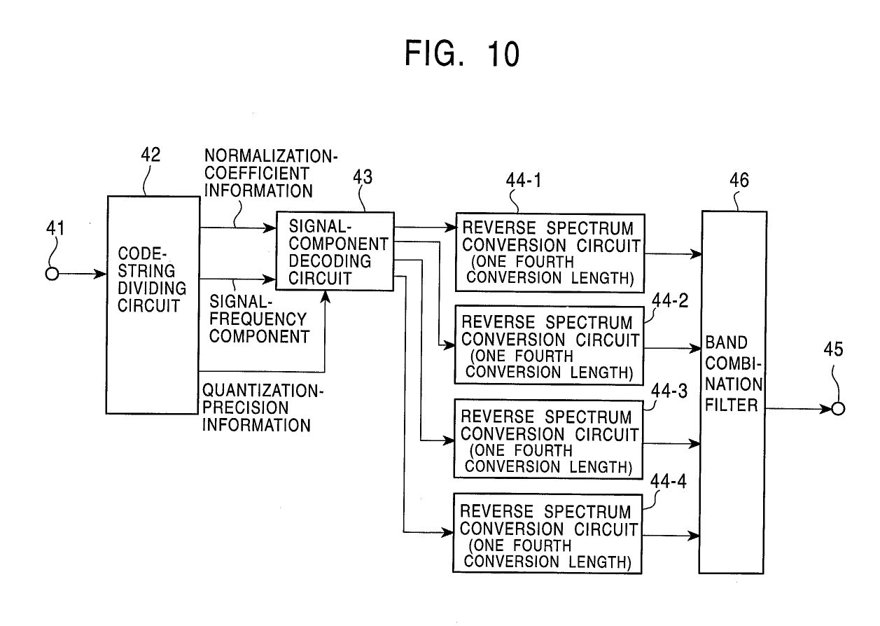

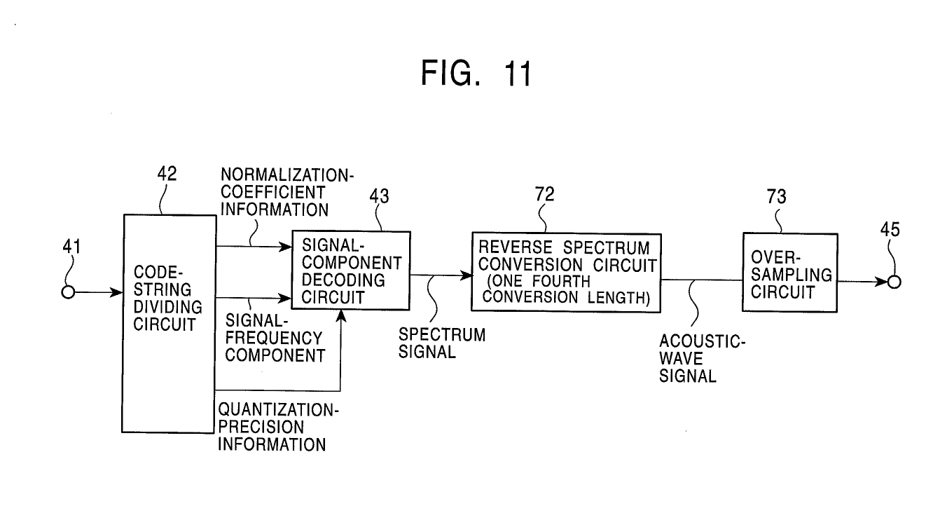

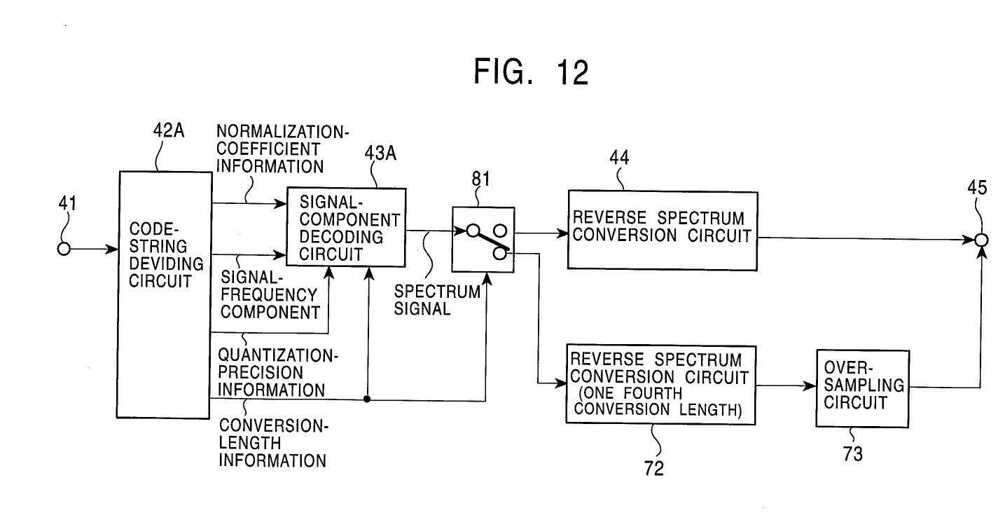

The switching circuit 81 outputs the spectrum signal to the reverse spectrum conversion circuit 44 when the conversion length of the decoded spectrum signal is the same as the conversion length M′ used in the spectrum conversion circuit 12 shown in FIG. 3, and outputs the spectrum signal to the conversion-length conversion circuit 91 when the conversion length is the same as the conversion length (M′/4) used in the spectrum conversion circuits 12-1 to 12-4 shown in FIG. 9.

When the conversion-length conversion circuit 91 receives the spectrum signal corresponding to the conversion length M′/4, it adds a frequency component having a value of zero to the spectrum signal to generate a spectrum signal in the frequency band corresponding to the conversion length M′ used in the spectrum conversion circuit 12 shown in FIG. 3 as indicated by equation (8), and outputs it to the reverse spectrum conversion circuit 44.

As described above, the reverse spectrum conversion circuit 44 receives the spectrum signal corresponding to the conversion length M′ from the switching circuit 81 or the conversion-length conversion circuit 91.

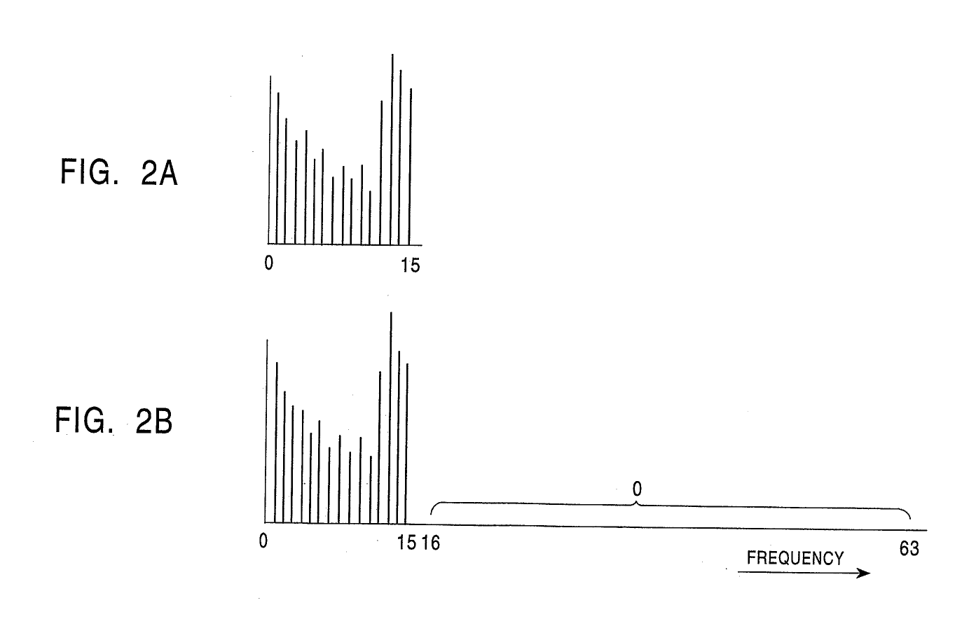

When the conversion length (M′/4) in the spectrum conversion circuits 12-1 to 12-4 shown in FIG. 3 is 16, for example, a spectrum signal having 16 frequency components is input to the conversion-length conversion circuit 91 as shown in FIG. 2A.

The conversion-length conversion circuit 91 adds 48 frequency components having a value of zero to the spectrum signal at the higher-frequency side as shown in FIG. 2B to generate a spectrum signal corresponding to a conversion length of 64 (=M′).

The reverse spectrum conversion circuit 44 applies reverse spectrum conversion to the spectrum signal corresponding to a conversion length of M′ sent from the switching circuit 81 or the conversion-length conversion circuit 91 at the same conversion length M′ of that used in the spectrum conversion circuit 12. In other words, the reverse conversion circuit 44 applies the processing reverse to that in the spectrum conversion circuit 12 shown in FIG. 3 to the spectrum signal corresponding to a conversion length of M′. Specifically, IMDCT operations expressed by equations (9) to (11) are performed.

$$\begin{matrix}{x}_{2 , J} ( n ) = {\sum }_{k = 0}^{{M}^{′} - 1} {X}_{J}^{′} ( k ) cos \frac{π ( 2 k + 1 ) ( 2 n + {M}^{′} + 1 )}{4 {M}^{′}} \\ 0 \leq n < 2 {M}^{′} & ( 9 ) \\ {x}_{3 , J} ( n ) = {w}_{2} ( n ) {x}_{2 , J} ( n ) \\ 0 \leq n < {M}^{′} & ( 10 ) \\ y ( n + {JM}^{′} ) = {x}_{3 , J - 1} ( n + {M}^{′} ) + {x}_{3 , J} ( n ) \\ 0 \leq n < {M}^{′} \\ Where {M}^{′} = 4 \times M . & ( 11 )\end{matrix}$$

As described above, when an input code string has a conversion length (for example, M′/4) other than the specified conversion length M′, since the conversion-length conversion circuit 91 adjusts the frequency band of the spectrum signal to convert it to the spectrum signal corresponding to the specified conversion length M′, a code string having a plurality of conversion lengths can be reproduced.

Since a frequency band is adjusted in this way before reverse spectrum conversion, the oversampling circuit 73 becomes unnecessary. In addition, because all processing can be performed only by the reverse spectrum conversion circuit 44, the circuit scale can be reduced.

In the above embodiment, the ratio (M/M′) of the two conversion lengths is set to ¼. The ratio may be set to a reciprocal of a power of 2, such as ½ and ⅛, or to other values.

MDCT is used for spectrum conversion in the above embodiment. Other methods can be used.

The present invention can be applied not only to an audio signal but also to a video signal.

What is claimed is:

1. A signal reproduction apparatus comprising:
decoding means for decoding a code string generated by coding a spectrum signal in the frequency domain obtained by applying spectrum conversion to an acoustic wave signal in the time domain at a first conversion length or a second conversion length;
first conversion means for converting the spectrum signal having said first conversion length generated by said decoding means to a spectrum signal in the frequency band corresponding to said second conversion length; and
second conversion means for applying reverse spectrum conversion at said second conversion length to the spectrum signal having said second conversion length generated by said decoding means or the spectrum signal having said second conversion length generated by said first converting means.

2. A signal reproduction apparatus according to claim 1, wherein said spectrum conversion is a modified discrete cosine conversion, and said reverse spectrum conversion is a reverse modified discrete cosine conversion.

3. A signal reproduction apparatus according to claim 1, wherein said first conversion length equals said second conversion length multiplied by a reciprocal of a power of 2.

4. A signal reproduction method comprising the steps of:
decoding a code string generated by coding a spectrum signal in the frequency domain obtained by applying spectrum conversion to an acoustic wave signal in the time domain at a first conversion length or a second conversion length;
converting the spectrum signal having said first conversion length generated by said decoding to a spectrum signal in the frequency band corresponding to said second conversion length; and
applying reverse spectrum conversion at said second conversion length to the spectrum signal having said second conversion length generated by said decoding or by said converting.
